(19) United States
(12) Patent Application Publication
(10) Pub. No.: US 2022/0239552 A1
(43) Pub. Date: Jul. 28, 2022

(54) PREDICTIVE CONTENT PROCESSING ESTIMATOR

(71) Applicant: ARRIS Enterprises LLC, Suwanee, GA (US)

(72) Inventor: Niranjan H. KOLHEKAR, Bangalore (IN)

(73) Assignee: ARRIS Enterprises LLC, Suwanee, GA (US)

(21) Appl. No.: 17/584,839

(22) Filed: Jan. 26, 2022

Related U.S. Application Data
(60) Provisional application No. 63/142,789, filed on Jan. 28, 2021.

(51) Int. Cl. H04L 41/0668; H04L 41/0663; H04L 41/0213; H04L 41/16

(52) U.S. Cl. CPC H04L 41/0668; H04L 41/16; H04L 41/0213; H04L 41/0663

(57) ABSTRACT

A system for managing network devices of a communications network includes a management system and agents associated with network devices. The management system receives faults and based upon a machine learning system attempt to mitigate the faults based upon either an on-line or an off-line mitigation process.

### CROSS-REFERENCE TO RELATED APPLICATIONS

The present application claims the benefit of U.S. Provisional Patent Application No. 63/142,789 filed Jan. 28, 2021.

### BACKGROUND OF THE INVENTION

A network management system can be associated with communication networks, with the purpose of collecting alarms from network equipment, forming a summary of the collected alarms, particularly using correlation methods, and displaying this alarm summary to an operator so that the operator can implement corrective action in the case of a failure of the network equipment. The concept of a “failure” or “fault” is understood to be a very general term for any type of hardware and/or software malfunction. Network equipment and/or software that is no longer operational in some manner is considered to have a failure. Likewise, an improper configuration of network equipment and/or software is considered to have a failure.

Network management systems can be used to configure network equipment and/or software. The operator can input new parameters using a man-machine interface and the network management system applies these new parameters to the network equipment and/or software. In this way, the operator can correct a network failure in reaction to an alarm.

Such a centralized analysis depends on collection of a large amount of data and alarms from many elements in the communication system. These elements may be network equipment, such as for example, routers, switches, computer servers, networking cards and other components of computer servers, inclusive of software.

Due to the many interactions between network elements, a single failure can generate a substantial number of alarms. Thus, a failure on a router may generate an alarm from other network equipment connected to one of the ports on the router. It is therefore difficult for the operator to determine which is the genuine failure among the large number of generated alarms, and even more so to determine the corrective action to be undertaken.

Nevertheless, the operator has to take action with each failure to determine the corrective action(s) to be undertaken and to undertake the corrective action(s). The operator then needs to reconfigure the network equipment using the network management system or to manually connect to one or more of the network equipment and send the appropriate CLI (command line interface) commands.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a communication network.

FIG. 2 illustrates a list of network devices.

FIG. 3 illustrates a list of network devices.

FIG. 4 illustrates a management system.

FIG. 5 illustrates a log file.

FIG. 6 illustrates an e-mail notification.

FIG. 7 illustrates a fault-based query.

FIG. 8 illustrates a fault-based query.

FIG. 9 illustrates a fault-based query.

FIG. 10 illustrates a fault-based query.

FIG. 11 illustrates a file directory with log files.

FIG. 12 illustrates characteristics of a file directory.

FIG. 13 illustrates various log files in a file directory.

FIG. 14 illustrates a log file.

FIG. 15 illustrates portions of the log file of FIG. 14.

FIG. 16 illustrates an on-line and an off-line management system.

FIG. 17 illustrates an on-line processing set of steps.

FIG. 18 illustrates an off-line processing set of steps.

### DETAILED DESCRIPTION OF PREFERRED EMBODIMENT

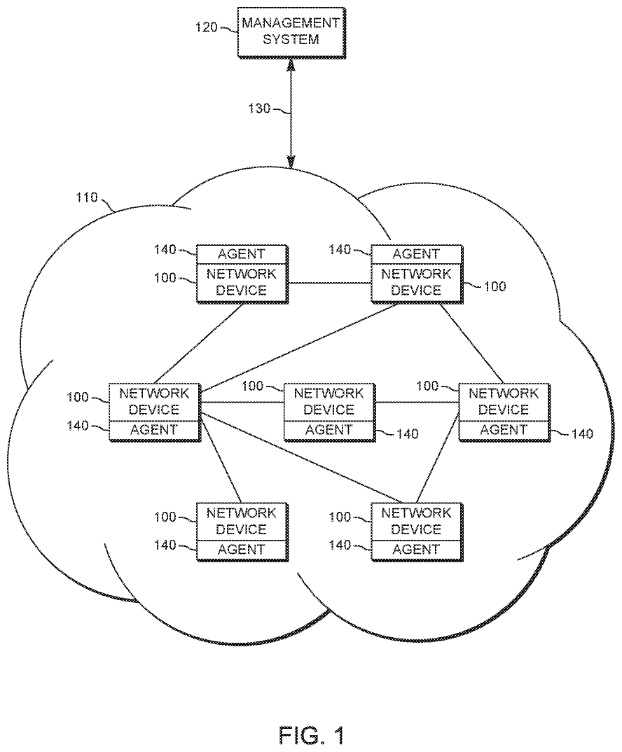

Referring to FIG. 1, a communication network 110 may include one or more network devices 100. The network devices may be any suitable type of device, such as for example, cable modems, routers, switches, servers, workstations, printers, bridges, hubs, IP telephones, IP video cameras, computer servers, and software applications. Each of the network devices 100 may include any type of hardware device and/or software that is interconnected to a network, such as within a communication network 110. Each of the network devices 100 may be interconnected to any other type of hardware device and/or software, such as within the communication network 110. Each of the network devices 100 may be interconnected with a management system 120, such as using a network connection 130.

The network devices 100 and the management system 120 may be interconnected with one another using any protocol. For example, a simple network management protocol (SNMP) may be used for collecting and organizing information about managed devices and software on an Internet protocol network and for modifying that information to change the network device and/or software behavior. SNMP may be used to expose management data in the form of variables on devices and/or software to be managed. Normally, SNMP enables the variables to be remotely queried, and often manipulated, by the management system 120. Each of the network devices 100 includes a respective agent 140 which reports information via SNMP to the management system 120. The agent 140 may permit unidirectional (read-only) or bidirectional (read and write) access to network device specific information. The agent 140 is a network management software module that resides on the respective network device and has local knowledge of the management information and translates that information to and/or from a SNMP specific form. The information from the respective agent 140 may be polled and/or pushed to the management system 120. In this manner, the management system 120 receives information from each of the respective agents 140, either on a regular basis or in response to a request. The agents 140 may further provide alerts to the management system 120 of a failure of the corresponding network device and/or software 100.

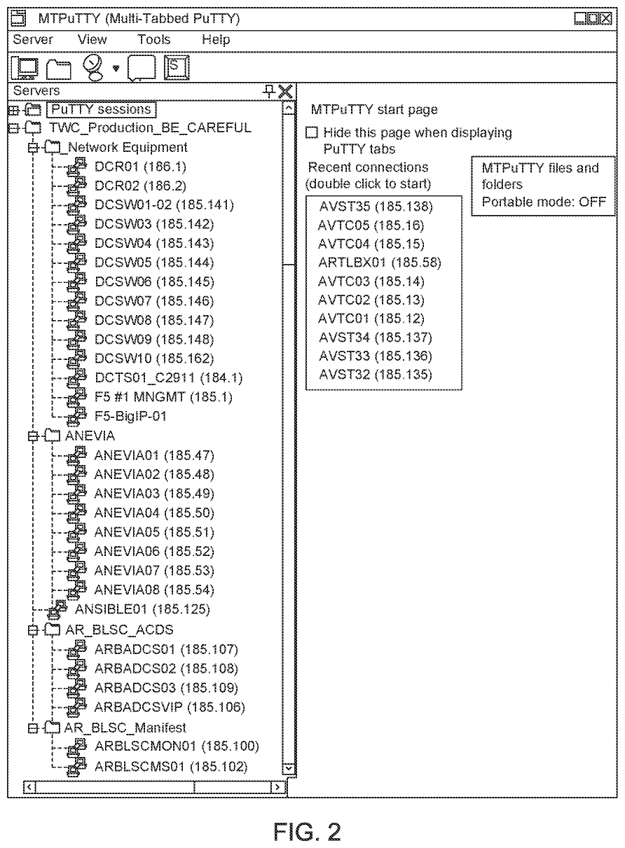

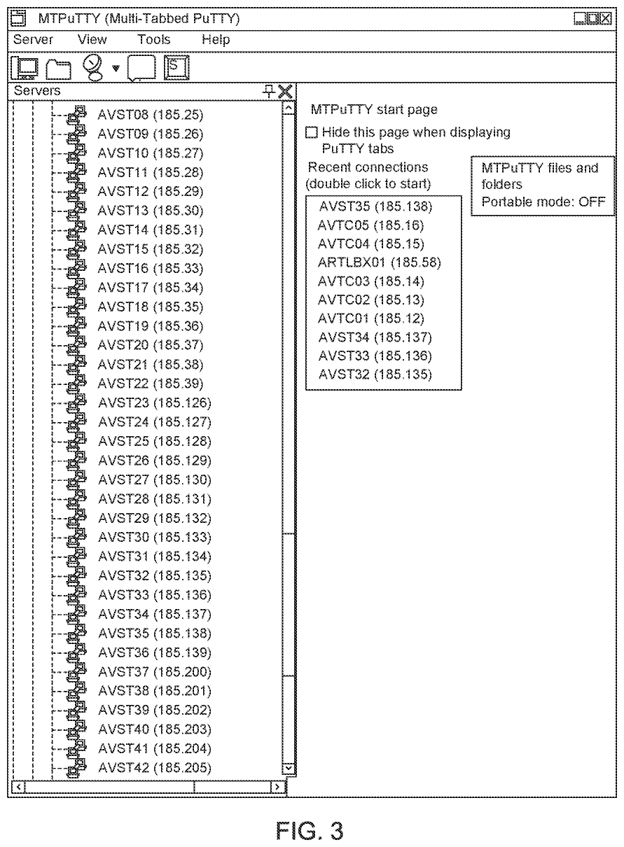

Referring to FIG. 2 and FIG. 3, the management system 120 may include a hierarchical list of network devices, such as organized by device name and a corresponding network address identification. An operator may examine each of the network devices, which may be within different directory structures, to determine the characteristics of each of the network devices as provided from the corresponding agent. For a relatively complicated set of network devices there may over 100 lists of network devices, with a substantial number of network devices (e.g., computer servers) listed within each list. In the event of a fault, it can be problematic to identify the network device with the error within the multitude of lists and devices therein. To simplify the identification of network devices that have an identified fault, an additional software program may be used to graphically illustrate which devices have a fault, such as a red indication of a fault or a green indication of no fault. While the identification of a fault may be identified from the list of devices, or the graphical illustration, it is problematic to determine an appropriate action to mitigate the issue.

For example, a router card may experience a failure. The management system 120 may receive a fault notification together with additional information from a corresponding agent 140 for the router card. Based upon the additional information a support engineer may attempt to diagnose the source of the fault notification. Initially, the support engineer may determine it is desirable to initiate a rebooting of the router card to attempt to remedy the fault condition. If the router card, as a result of rebooting the router card, operates properly then the corrective action was successful.

For example, a manifest delivery controller is a software application running on a computer server for modifying video manifests to enable server-side dynamic advertisement insertion, content personalization, and analytics for Internet protocol-based video. The management system 120 may receive a fault notification together with additional information from a corresponding agent 140 for the manifest delivery controller that has failed. Based upon the additional information a support engineer may attempt to diagnose the source of the fault notification. Initially, the support engineer may determine it is desirable to initiate a rebooting of the manifest delivery controller to attempt to remedy the fault condition. If the manifest delivery controller, as a result of rebooting the manifest delivery controller, fails to operate properly then the support engineer needs to further examine the logs to attempt to determine an appropriate course of action. Unfortunately, it can be rather time consuming to determine an appropriate course of action.

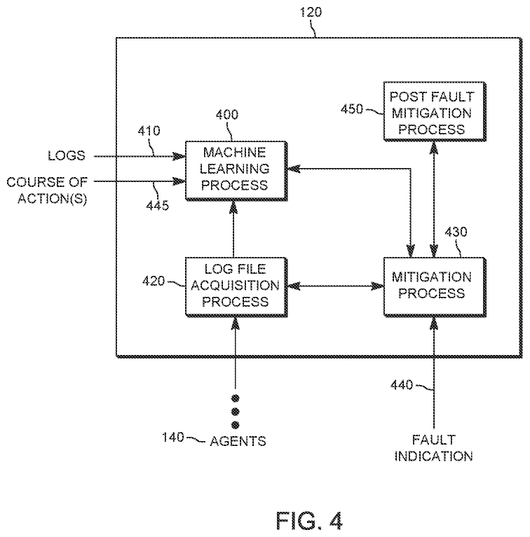

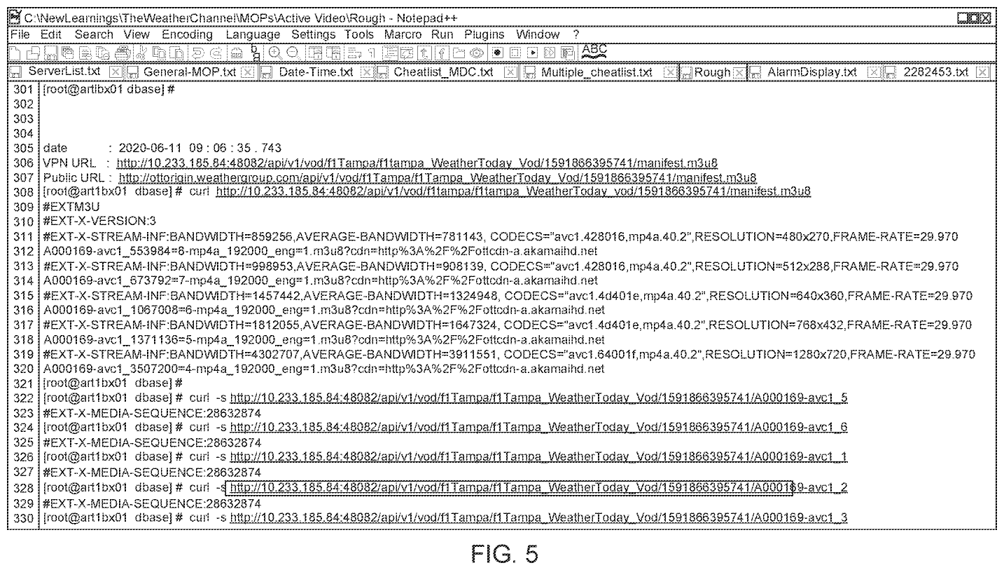

Referring to FIG. 4, the management system 120 may include a machine learning process 400 that builds a model based upon sample data, generally referred to as training data, in order to make decisions without having to be explicitly programmed to do so. Any machine learning technique may be used, including for example, supervised learning, unsupervised learning, reinforcement learning, topic modeling, dimensionality reduction, deep learning, and meta learning. The training data may include logs 410, such as an exemplary log illustrated in FIG. 5, from each of the respective network devices 100 together with a course of action 415 that was used to repair the fault and/or course of actions that did not result in repair of the fault, each of which may include one or more actions. With a sufficiently large set of training data that includes the course of actions that were successful and/or unsuccessful, the machine learning process 400 may have a trained state.

The management system 120 may include a log file acquisition process 420 that retrieves the log files from the corresponding network devices 100 upon a fault being detected, or otherwise periodically receives and updates the log files from the network devices 100 on a continual basis. In this manner, when a fault is triggered for one or more network devices 100 by a corresponding one or more agents 140, the log files have already been received by the log file acquisition process 420 or otherwise received by the log file acquisition process 420 in response to receiving one or more faults. A mitigation process 430 receives the fault indication 440 and, based upon the corresponding log files from the log file acquisition module 420, processes the log files using the trained machine learning process 400. In response, the mitigation process 430 suggests an appropriate manner of mitigating the fault. Based upon any suitable criteria, the mitigation process 430 may automatically perform the determined one or more mitigation activities. If as a result of the automatic mitigation activities, such as restarting the device and/or software process or reinstalling and/or reconfiguring the device and/or software process, the fault remains then the fault may be elevated to an appropriate support engineer with supporting documentation regarding the fault, including appropriate suggestions from the machine learning process 400 based upon previous encounters with the same or similar faults.

The support engineer may go through the log files that have been retrieved by the log file acquisition process 420, together with examination of additional data remaining on the network devices 100, if desired, to make an analysis of what is the likely root cause for the fault.

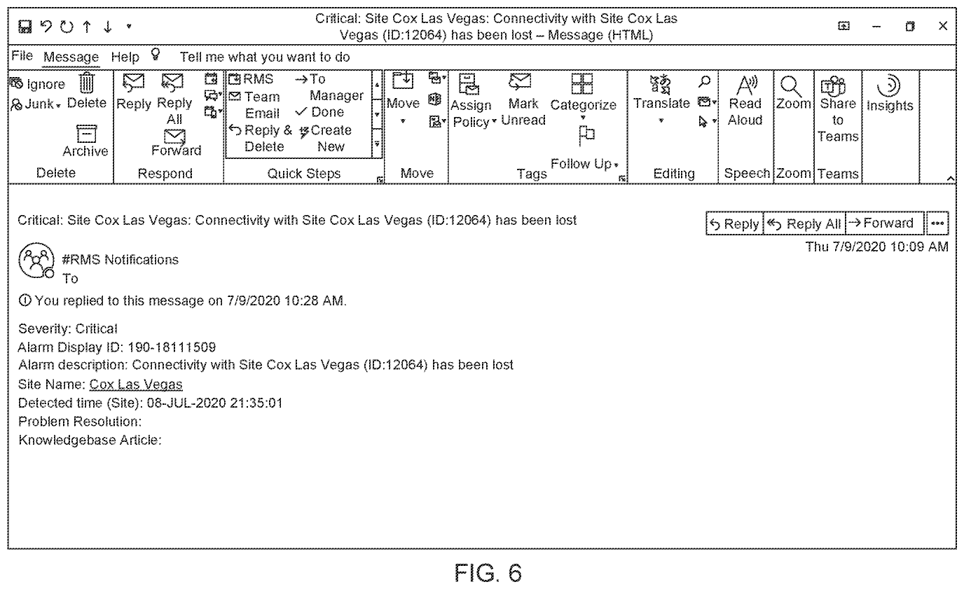

Referring to FIG. 6, by way of example, the management system 120 may receive e-mail alerts of faults, such as each time a network device loses network connectivity. If desired, the e-mail alerts that identify faults may be processed by the mitigation process 430 to attempt an automated mitigation of the fault.

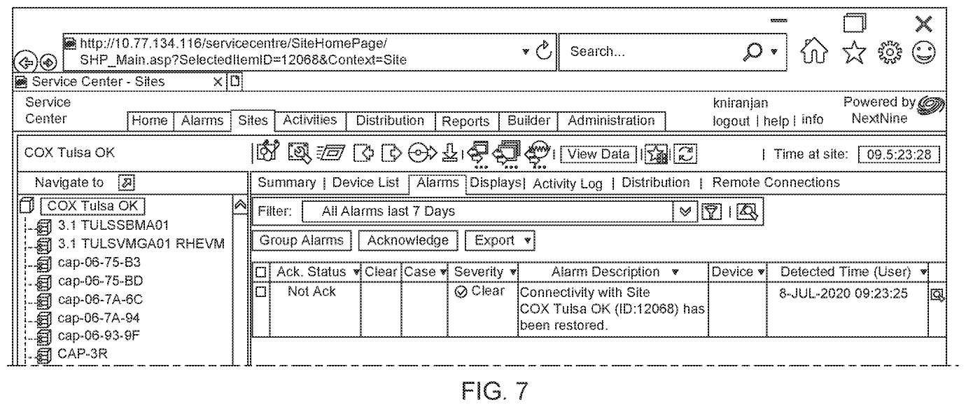

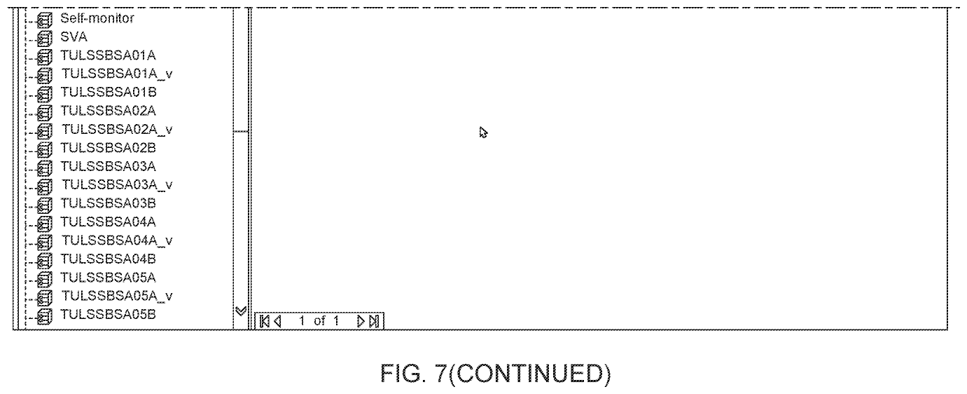

Referring to FIG. 7, by way of example, the management system 120 may identify faults, such as each time a network device loses network connectivity, based upon a search of the network devices using an interface. If desired, the faults may be processed by the mitigation process 430 to attempt an automated mitigation of the fault.

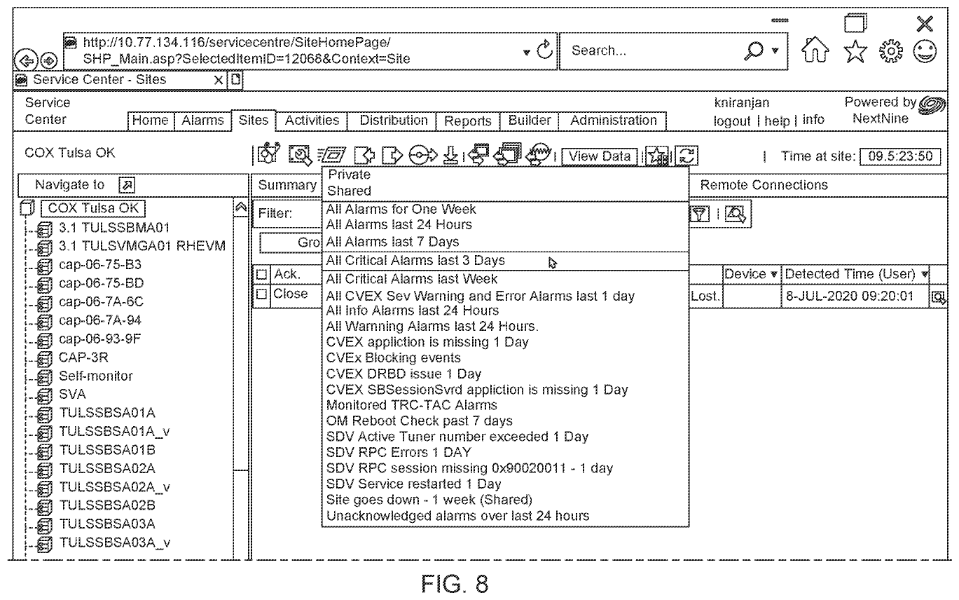

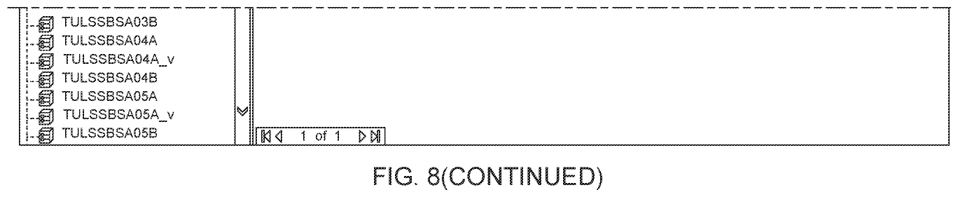

Referring to FIG. 8, by way of example, the management system 120 may identify faults based upon a search criteria, such as each time a network device loses network connectivity based upon the search criteria, based upon a search of the network devices using an interface. If desired, the faults may be processed by the mitigation process 430 to attempt an automated mitigation of the fault.

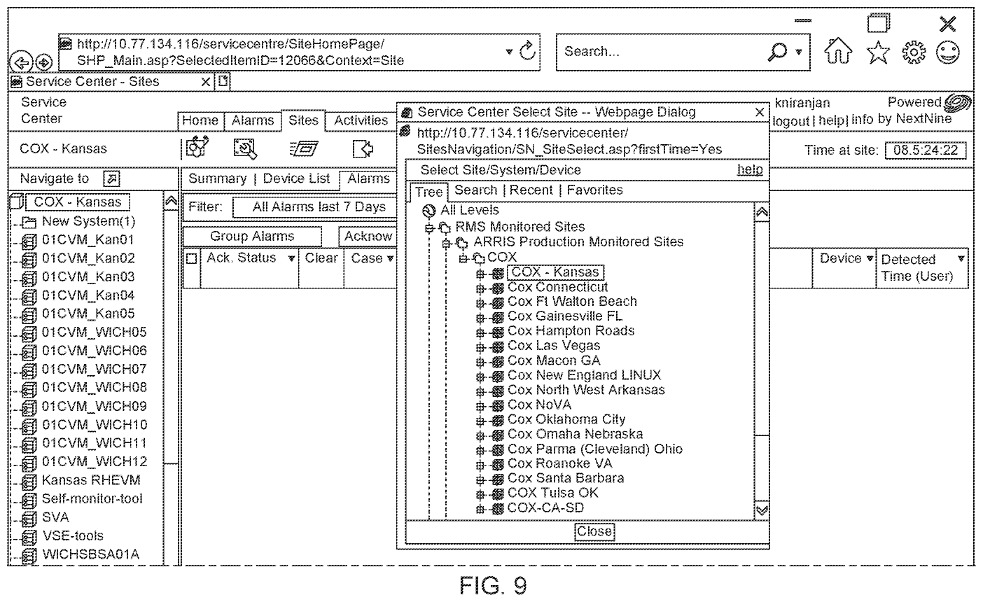

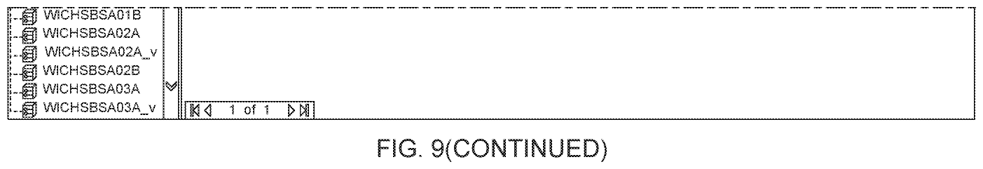

Referring to FIG. 9, by way of example, the management system 120 may identify faults based upon a geographic search criteria, such as each time a network device loses network connectivity based upon the search criteria, based upon a search of the network devices using an interface. If desired, the faults may be processed by the mitigation process 430 to attempt an automated mitigation of the fault.

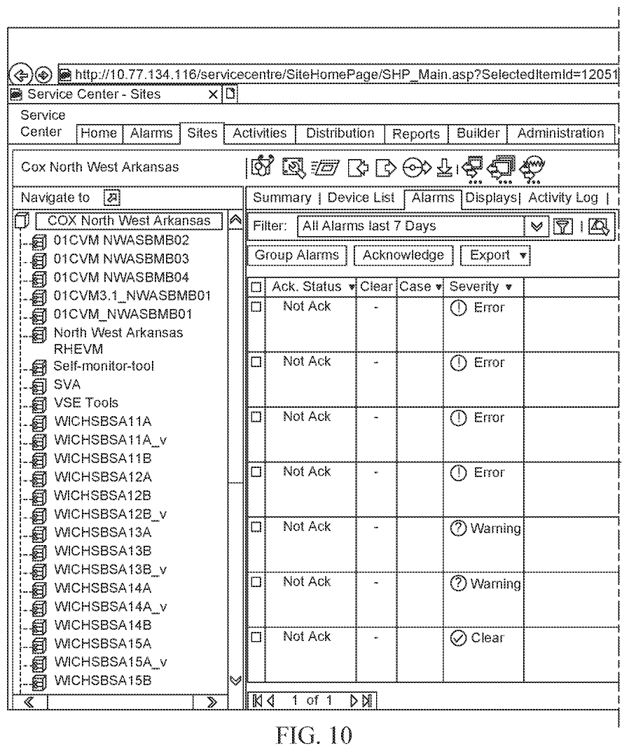

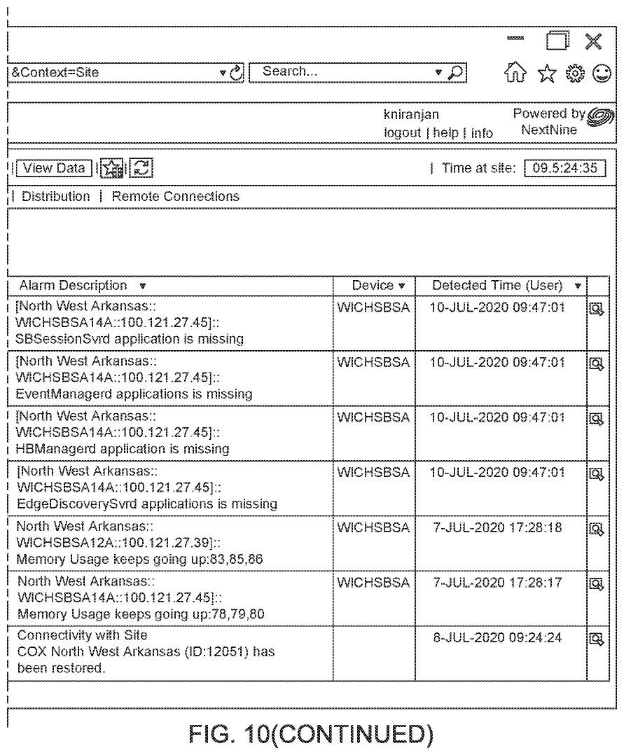

Referring to FIG. 10, by way of example, the monitoring system may identify faults based upon a temporal search criteria, such as each time a network device loses network connectivity based upon the search criteria, based upon a search of the network devices using an interface. If desired, the faults may be processed by the mitigation process 430 to attempt an automated mitigation of the fault. It is noted, that in general, the faults may have several different severities, such as an error or a warning.

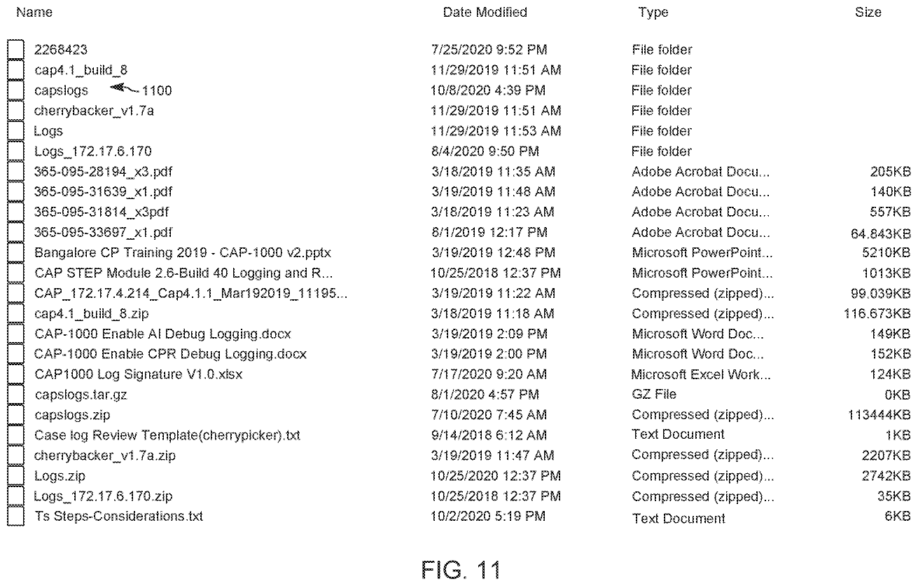

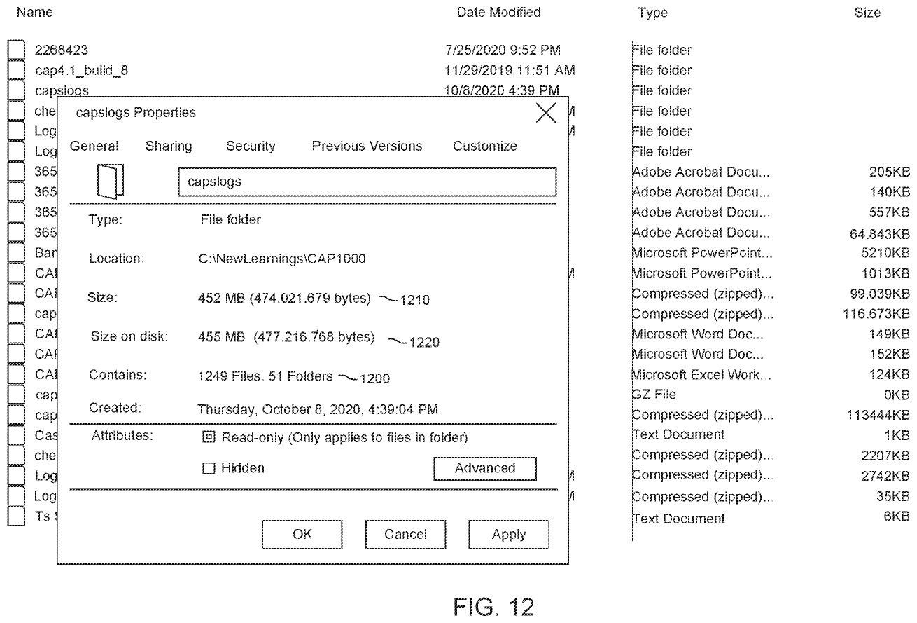

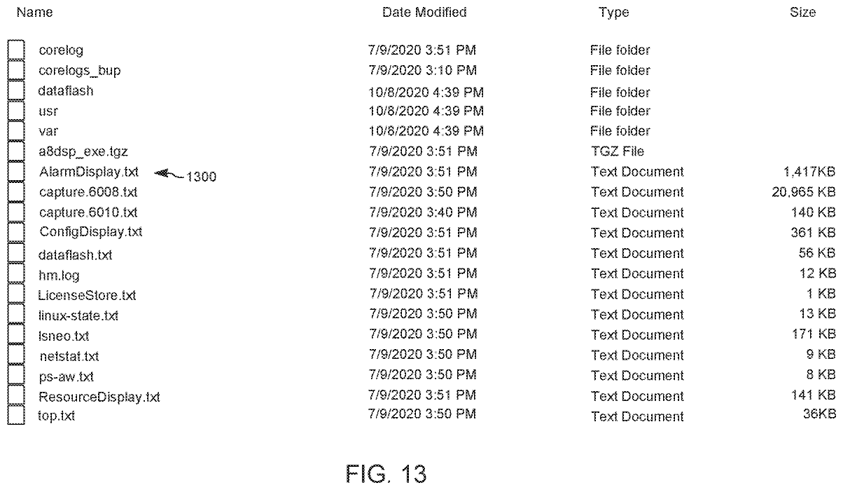

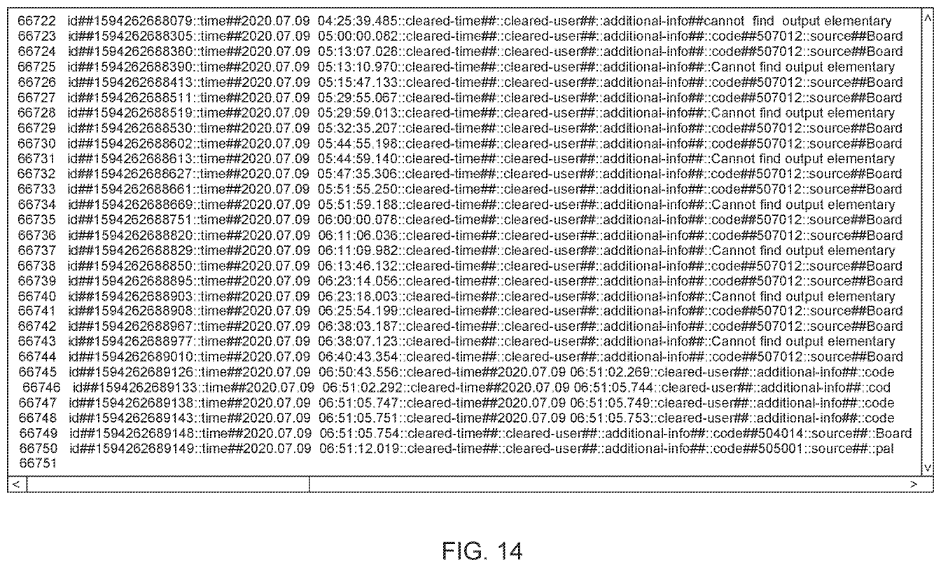

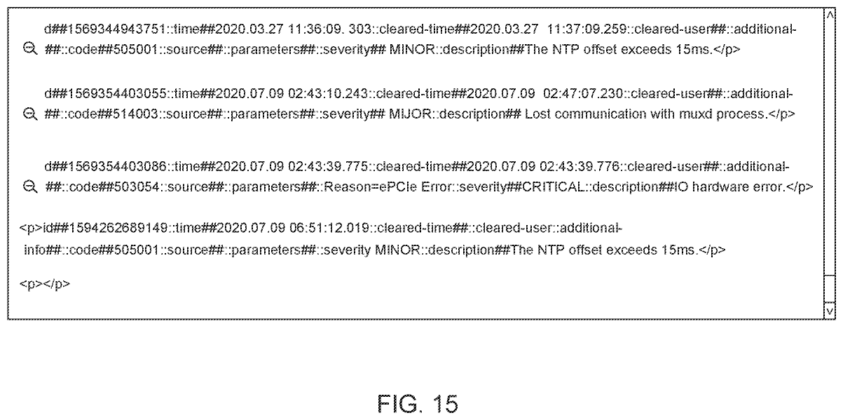

In many cases, there is a lot of effort involved by a front-line engineer involved to analyze and process a fault from the system and/or a customer. Referring to FIG. 11, in many cases the log files are maintained in one or more file folders on one or more servers of the system, such as a file folder named “capslogs” 1100. Referring to FIG. 12, the capslogs file folder 1100 may contain a substantial number of file folders 1200 (e.g., 51 folders) and each of the file folders may include a substantial number of files 1210 (e.g., 1249 files) all of which are substantial in size 1220 (e.g., 455 MB). Referring to FIG. 13, the capslog file folder 1100 may include a multitude of different types of data files, such as for example AlarmDisplay.txt 1300. Referring to FIG. 14, a portion of an exemplary AlarmDisplay.txt 1300 file is illustrated that includes a substantial amount of information (e.g., over 65,000 lines). As previously indicated, the front-line engineer as a result of receiving an indication that a fault has arisen, needs to investigate the issue, diagnose the issue, and determine an appropriate course of action. With a substantial number of files, each of each may include tens of thousands of lines of information, it is a daunting task to identify the faults, the number of times each type of fault occurred, the times that the faults occurred, and to determine the significance of any such faults. After determining the significance of any such faults, an action plan may be determined and proposed to the customer. The customer then may execute the proposed action plan. The customer may then provide feedback on whether the proposed action plan was successful, or whether the proposed action plan was unsuccessful. This process is burdensome and time consuming, taking hours to days, together with substantial opportunity to introduce errors into the process. Referring to FIG. 15, an exemplary portion of the Alarm Distplay.txt file illustrates some indicates of one or more identified faults.

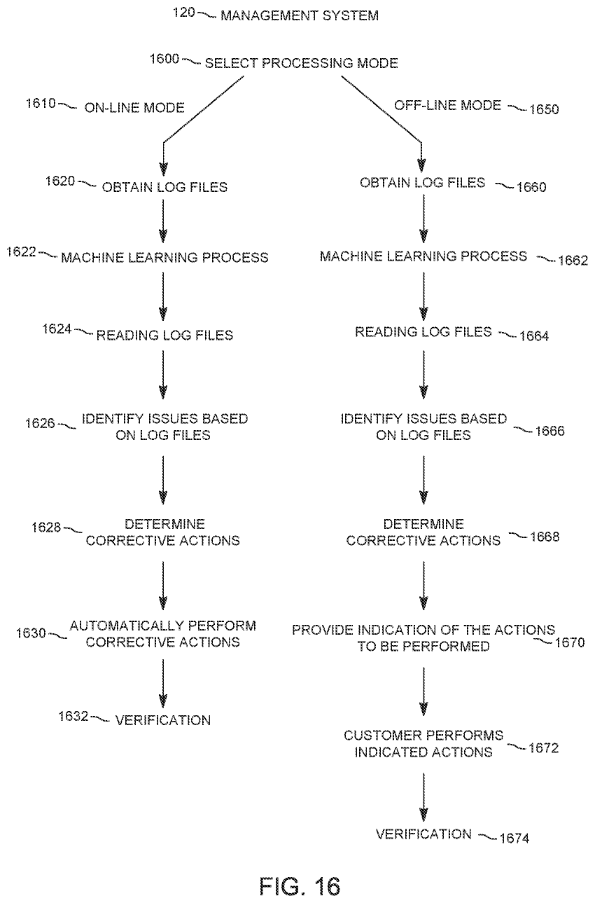

Referring to FIG. 16, the management system 120 may include a plurality of processing modes 1600 that are selectable by an operator to assist in the troubleshooting of faults. The operator may select an online mode 1610. In the on-line mode 1610, the management system 120 may obtain log files 1620 from the customer through a network interconnection, such as the Internet. The log files 1620 are preferably obtained in an automated manner not requiring the customer to provide the log files. The log files, for example, may be received by a simple network management protocol or a file transfer protocol. One or more of the log files may be provided to the machine learning process 1622 for processing. The machine learning process 1622 may perform a multitude of processing steps. An initial step the machine learning process 1622 may perform is reading the log files 1624. The machine learning process 1622 may identify issues 1626 based upon the log files. The machine learning process 1622 may determine corrective actions 1628 to be taken based upon the identified issues 1626. Based upon the determined correction actions 1628, the management system 120 may automatically perform corrective action 1630. The automatic correction actions 1630 may further be based upon providing an indication of the actions to be performed and a response from the engineer that those actions are appropriate before automatically performing the correction actions 1630. After performing the automatic correction actions 1630, the management system 120 may automatically perform verification 1632 to ensure that the faults have been resolved.

The operator may select an off-online mode 1650. In the off-line mode 1650, the management system 120 may obtain log files 1660 from the customer through a network interconnection, such as the Internet. The log files 1660 are preferably provided by the customer in some manner, such as using shared cloud-based storage. The log files, for example, may be provided using a simple network management protocol or a file transfer protocol. One or more of the log files may be provided to the machine learning process 1662 for processing. The machine learning process 1662 may perform a multitude of processing steps. An initial step the machine learning process 1662 may perform is reading the log files 1664. The machine learning process 1662 may identify issues 1666 based upon the log files. The machine learning process 1662 may determine corrective actions 1668 to be taken based upon the identified issues 1666. Based upon the determined correction actions 1668, the management system 120 may provide an indication of the actions 1670 to be performed by the customer. The customer may perform the actions that are indicated 1672. After performing the actions that are indicated 1672, the management system 120 may perform verification 1674 to ensure that the issues have been resolved.

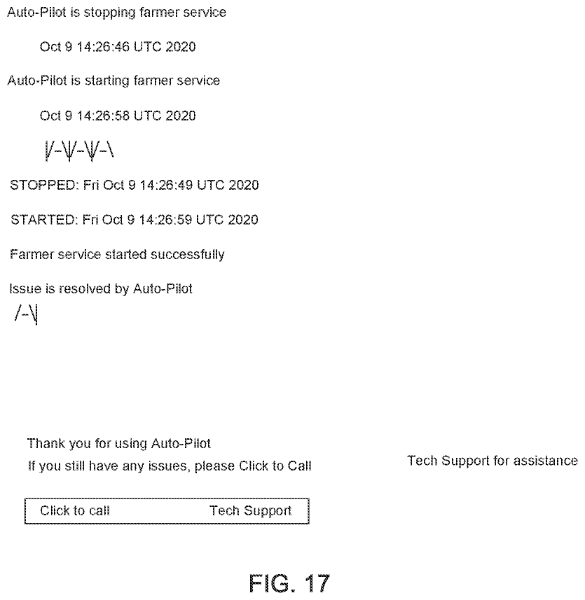

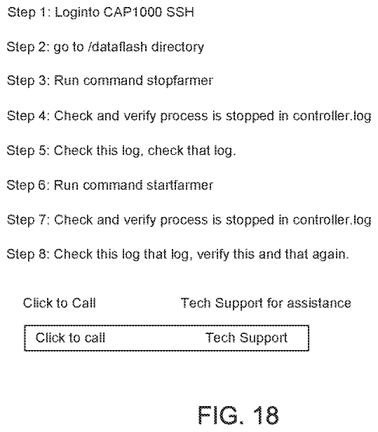

As it may be observed, the dual option system using an on-line mode and an off-line mode, permits the management system 120 to efficiently and accurately process log files that include faults in a manner that documents what is performed for future reference together with resolving the issues in a verifiable manner. Referring to FIG. 17, an exemplary automated set of steps that is performed is illustrated. Referring to FIG. 18, an exemplary set of manual steps to be performed is illustrated.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A method for managing network devices of a communications network comprising:
(a) receiving, by a management system, first log information from a first agent associated with a first said network device of said communications network;
(b) receiving, by said management system, an indication that a fault has occurred for at least one of said network devices;
(c) based, by said management system, upon receiving said fault, a machine learning process identifying a first source of said fault based upon said first log information;
(d) based upon identifying said first source of said first fault said management system selectively either (i) automatically performing an on-line mitigation process to attempt to remedy a cause of said first fault, and (ii) providing instructions of an off-line mitigation process to attempt to remedy a cause of said first fault.

2. The method of claim 1 wherein said first agent and said management system are interconnected with one another using a simple network management protocol.

3. The method of claim 1 wherein said first network device is a hardware device.

4. The method of claim 1 wherein said first network device is software.

5. The method of claim 1 wherein said first log information includes variables on said first network device.

6. The method of claim 1 wherein said machine learning process is trained based upon log information from network devices together with fault information.

7. The method of claim 1 wherein said machine learning process is trained based upon courses of action that resulted in repairs of faults.

8. The method of claim 1 wherein said machine learning process is modified based upon said first log information and said first fault.

9. The method of claim 8 wherein said machine learning process is modified based upon a mitigation of said first fault.

10. The method of claim 9 wherein said mitigation of said first fault includes one or more actions that mitigated said first fault.

11. The method of claim 1 wherein a selection between said on-line mitigation process and said off-lien mitigation process is selected based upon an input from an operator.

12. The method of claim 1 further comprising verification that said first fault has been remedies by said on-line mitigation process.

13. The method of claim 1 further comprising verification that said first fault has been remedies by said off-line mitigation process.

14. A computer, that includes a processor, for managing network devices of a communications network comprising:
(a) a management system operating on said computer receives first log information from a first agent associated with a first said network device of said communications network;
(b) said management system receives an indication that a fault has occurred for at least one of said network devices;
(c) said management system based upon receiving said fault uses a machine learning process identifying a first source of said fault based upon said first log information;
(d) said management system based upon identifying said first source of said first fault said management system selectively either (i) automatically performing an on-line mitigation process to attempt to remedy a cause of said first fault, and (ii) providing instructions of an off-line mitigation process to attempt to remedy a cause of said first fault.

15. The computer of claim 14 wherein said first agent and said management system are interconnected with one another using a simple network management protocol.

16. The computer of claim 14 computer wherein said machine learning process is trained based upon log information from network devices together with fault information.

17. The computer of claim 14 wherein said machine learning process is trained based upon courses of action that resulted in repairs of faults.

18. The computer of claim 14 wherein said machine learning process is modified based upon said first log information and said first fault.

19. The computer of claim 18 wherein said machine learning process is modified based upon a mitigation of said first fault.

20. The computer of claim 19 wherein said mitigation of said first fault includes one or more actions that mitigated said first fault.

21. The computer of claim 14 wherein a selection between said on-line mitigation process and said off-lien mitigation process is selected based upon an input from an operator.

22. The computer of claim 14 further comprising verification that said first fault has been remedies by said on-line mitigation process.

23. The computer of claim 14 further comprising verification that said first fault has been remedies by said off-line mitigation process.
